(19) United States
(12) Patent Application Publication
(10) Pub. No.: US 2006/0060034 A1
(43) Pub. Date: Mar. 23, 2006

(54) Open-end self-adjusting wrench

(76) Inventor: Calvin Litchfield, Elk Grove, CA (US)

Correspondence Address: James M. Ritchey;O'BANION and RITCHEY, LLP, Wells Fargo Center, 400 Capitol Mall, Suite 1550, Sacramento, CA, 95814, US

(21) Appl. No.: 10/947,125

(22) Filed: Sep. 22, 2004

(51) Int. Cl. B25B 13/12

(52) U.S. Cl. 81/127; 81/129

(57) ABSTRACT

An open-end self-adjusting wrench for use in grasping objects includes a jaw assembly having two slidably opposing jaws. A first jaw has an object gripping surface that extends into an aperture containing base. The aperture within the base includes two regions: a receiving channel proximate to the object gripping surface and a receiving slot distal to the object gripping surface. A second jaw has another object gripping surface and a toothed rail slidably mated within the receiving channel to produce object grasping alignment of the two gripping surfaces. Pivotally secured within the receiving slot is an elongated handle with a grasping region at one end and a toothed radial perimeter at the other end. The toothed rail and the toothed radial perimeter mesh to produce an object grasping force on the object between the opposing object grasping surfaces when appropriate force is exerted on the elongated handle grasping region.

### BACKGROUND OF THE INVENTION

1. Field of the Invention

This invention pertains generally to a wrench that automatically adjusts to the size of the grasp item and more particularly to an open-end adjustable wrench having first and second opposable jaws operationally linked an associated handle. A user places a selected item to grasp between the opposing jaws and when the user places increasing torque on the wrench handle the jaws of the wrench grip the selected item with increasing force.

2. Description of Related Art

Various types of wrenches have been known for many centuries, however, an extremely simplistic, structurally strong, inexpensive, and functional open-ended self-adjusting wrench has not existed before the subject invention.

In U.S. Pat. No. 5,016,503 an adjustable open end wrench is disclosed. Comprising the wrench are two opposing jaw members that move apart and together as a ratchet associated handle travels from a first position to a second position. A required element is a non-load carrying retainer means for keeping the devise assembled. Comprising the non-load carrying retainer means is either a retainer clip or a pin-in-slot retainer that serve to keep the two jaw members in proper functioning alignment.

U.S. Pat. No. 6,202,516 relates a self-adjusting wrench that consists of a wrench head into which is fitted a biased block. By means of a screw the biased block is extended or withdrawn to produce a smaller or larger, respectively, openings receiving a grasped object.

A self-adjusting socket for a wrench handle is presented in U.S. Pat. No. 5,768,961. A plurality of movable pins within a cylindrical housing shift position to accommodate and grasp a selected object.

Related in U.S. Pat. No. 4,890,520 is a self-adjusting gripping tool. Comprising the pliers-like tool are two handles pivotally attached to one another which extend into opposed gripping jaws. A biased ratchet means associated with a pivot region of the tool automatically locks the opposed gripping jaws into positions that grasp a selected object.

U.S. Pat. No. 6,092,440 shows a self-adjusting ratcheting wrench that comprises a handle that extends into a first gripping jaw. Pivotally secured to the handle proximate the first gripping jaw is a second C-shaped gripping jaw. Biasing means forces the two jaws together thereby grasping a desired object within the jaws. Means are provided for opening the jaws to receive the object to be grasped.

U.S. Pat. No. 5,553,520 makes known an open-end self-adjusting ratchet wrench comprising a handle terminating in a fastener grasping region. The fastener grasping region contains a generally circular fastener-receiving opening, surrounded by a plurality of biased grasping teeth that function to grip the desired fastener.

Depicted in U.S. Pat. No. 3,892,150 is a self-adjusting open or closed-end ratchet wrench in which opposing jaws move together or apart by means of a self-adjusting push-rod secured to one jaw and extend within a handle to a locking means.

### BRIEF SUMMARY OF THE INVENTION

An object of the invention is to provide a wrench that self-tightens and self-releases when grasping a bolt head, nut, and the like.

Another object of the invention is disclose a self-adjustable open-end wrench having two opposable jaws for clamping about a desired object and a ratchet associated handle employed by a user to engage the two opposable jaws to grasp and then release the desired object.

A still further object of the invention is present a simple, sturdy, and inexpensive open-end self-adjusting wrench comprising only three elements and a simple securing means, wherein a jaw assembly comprises reciprocating first and second jaw members that are associated with a ratcheted handle that both tightens the jaw members about a desired object when torque is exerted and loosens the jaw members when the torque is removed.

Further objects of the invention will be brought out in the following portions of the specification, wherein the detailed description is for the purpose of fully disclosing a preferred embodiment of the invention without placing limitations thereon.

Generally, the subject invention comprises an open-end self-adjusting wrench for use in grasping objects. The subject wrench includes a jaw assembly having first and second slidably opposing jaw members. A first jaw member has a first object gripping surface that extends into an aperture containing base. The aperture within the base includes two regions: a receiving channel proximate to the first object gripping surface and a receiving slot distal to the first object gripping surface. A second jaw member has a second object gripping surface and a toothed rail slidably mated within the receiving channel to produce an object grasping alignment of the first and second gripping surfaces. Pivotally secured within the receiving slot is an elongated handle with a grasping region at a first end and a toothed radial perimeter at a second end. The toothed rail and the toothed radial perimeter mesh with one another to produce an object grasping force on the object between the opposing first and second object grasping surfaces when appropriate force is exerted on the elongated handle grasping region.

More specifically, the subject invention comprises an open-end self-adjusting wrench for use in grasping variably sized objects that comprises a jaw assembly having a first jaw member with a first object gripping surface extending into a cavity containing base that has a first anchor pin receiving aperture. The cavity within the base comprises a key-rail channel proximate to the first object gripping surface and a handle-receiving slot distal to the first object gripping surface. A second jaw member has a second object gripping surface and a toothed key-rail for slidably mating within the key-rail channel, thereby aligning the first and the second object gripping surfaces to directly oppose one another. The toothed key-rail slides within the key-rail channel to grasp and release the object between the first and the second object gripping surfaces. Additionally, included is an elongated handle having first and second ends. Comprising. A user grasping region is located at the first end and a toothed radial perimeter formed at the second end. Also at the second end is a second anchor pin receiving aperture. Included is an anchor pin for pivotally securing the elongated handle second end within the receiving slot by means of the first and second anchor pin receiving apertures, thereby securing the meshing of the toothed key-rail with the toothed radial perimeter. The toothed key-rail and the toothed radial perimeter mesh with one another to produce an object grasping force on the object between the first and second object grasping surfaces when an appropriate torquing-rotational force is exerted on the elongated handle grasping region.

To facilitate extended meshing between the toothed key-rail and the toothed radial perimeter, pivot-facilitating notches bracket the toothed radial perimeter at the handle second end.

### BRIEF DESCRIPTION OF THE SEVERAL VIEWS OF THE DRAWING(S)

The invention will be more fully understood by reference to the following drawings which are for illustrative purposes only:

FIG. 1 is a top planar view of the subject invention.

FIG. 2A is top planar view of the subject invention showing the jaws of the wrench open and a nut about to be grasped.

FIG. 2B is top planar view of the subject invention showing the jaws of the wrench closed and grasping a nut.

FIG. 3 is side view of the subject invention showing the inter-relationship between the first jaw member fitted, the second jaw member, and the handle.

FIG. 4 is and exploded view of the jaw assembly showing the first jaw member and the second jaw member.

### DETAILED DESCRIPTION OF THE INVENTION

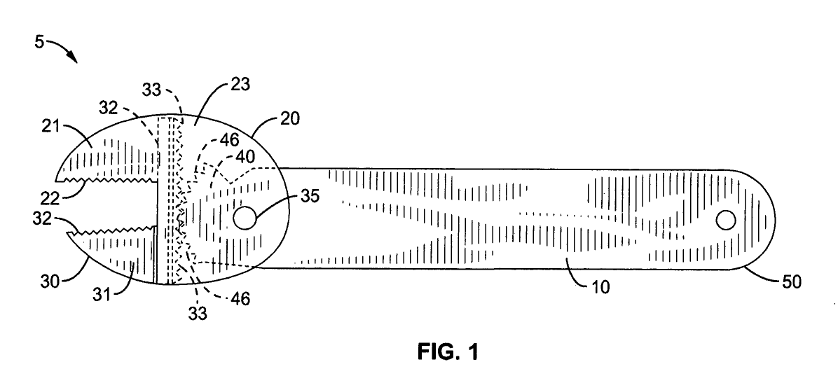

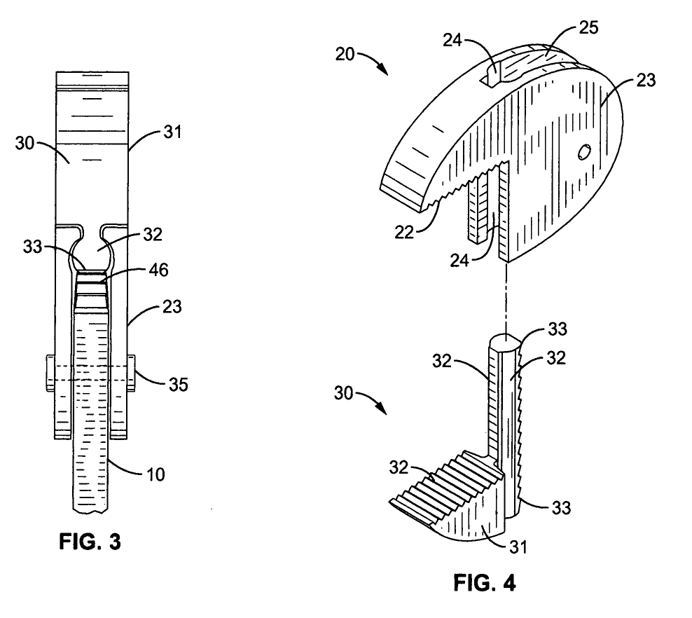

Referring more specifically to the drawings, for illustrative purposes the subject invention is embodied in the apparatus generally shown in FIGS. 1-4. It will be appreciated that the apparatus may vary as to configuration and as to details of the parts without departing from the basic concepts as disclosed herein.

Comprising the subject invention 5 are a handle 10 and a jaw assembly having a first jaw member 20 and a second jaw member 30 which are slidably mated or interfaced with one another and pivotally secured to the handle 10 by fastening means 35. The handle 10, with first 40 and second 50 ends, is utilized by a user to apply tortional force to an object to be grasped and turned. The elongated handle 10 has a grasping region between the first 40 and second ends 50. The user grasps the wrench and applies tortional force to the handle grasping region which is transmitted or applied to the slidably mated first 20 and second 30 jaw members via a coupling means between the handle 10 and first 20 and second 30 jaw members. More specifically, at the handle's first end is a grasping-force generating region comprising a radial perimeter containing multiple teeth 46 that mesh with a plurality of teeth 32 on the second jaw member 30.

The first jaw member 20 comprises a first object gripping jaw 21 having an object gripping surface 22 that is commonly a roughened surface to aid in grasping the desired object. The first object gripping jaw 21 extends into an aperture containing base region 23, wherein the aperture in the base region 23 comprises a receiving channel or key-rail channel 24 proximate to the first object gripping jaw 21 and a receiving slot 25 distal to said first object gripping jaw 21.

The second jaw member 30 comprises a second object gripping jaw 31 having an object gripping surface 32 that is commonly a roughened surface to aid in grasping the desired object, in conjunction/cooperation with the first object griping surface 22. The second object gripping jaw 31 extends into an elongated key-rail 32 have a plurality of teeth 33. When assembled, the toothed key-rail 32 mates within said key-rail channel 24, thereby aligning the first 22 and the second 32 object gripping surfaces to directly oppose one another, whereby the toothed key-rail 32 slides within the key-rail channel 24 to grasp and release the object between the first 22 and the second 32 object gripping surfaces. When the toothed key-rail 32 teeth 33 slidably mate with the handle's radial perimeter teeth 46 the force produced by the user is transmitted to grasping the desired object.

The fastening means 35 is an appropriate device or anchor pin such as a bolt/nut, rivet, screw/nut, and the like that penetrates apertures in the first jaw member 20 and handle 10, proximate the teethed radial perimeter end 40 to secure, in a freely pivotal manner, the handle 10 to the first jaw member 20.

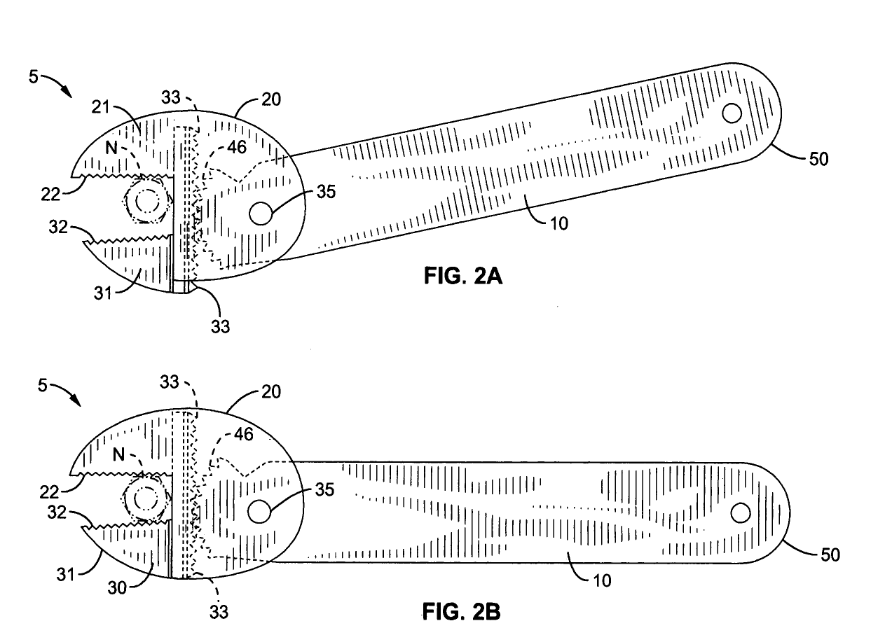

FIGS. 2A and 2B illustrate a typical operation for the subject invention. As seen in FIG. 2A, an object to be grasped within the subject jaw assembly, for example a nut N, is positioned within the jaw assembly with the first 20 and second 30 jaw members in an open position. The user then applies a rotating pressure to the handle 10. The handle 10 pivots about the fastening means 35, which forces the engaged teeth 33/46 to slide past one another, thereby tightening the jaw assembly 20/30 into the closed or object-grasping position seen in FIG. 2B. Opening the subject wrench occurs in reverse order to the steps just described.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An open-end self-adjusting wrench for use in grasping variably sized objects, comprising:
a) a jaw assembly comprising:
i) a first jaw member having a first object gripping surface extending into an aperture containing base region, wherein said aperture comprises a receiving channel proximate to said first object gripping surface and a receiving slot distal to said first object gripping surface;
ii) a second jaw member having a second object gripping surface and a first gripping force generating means slidably mated within said receiving channel;
b) an elongated handle having first and second ends comprising:
i) a grasping region at said first end and
ii) a second gripping force generating means at said second end, whereby said first and second gripping force generating means cooperate to produce an object grasping force on the object between said first and second object grasping surfaces when appropriate force is exerted on said elongated handle grasping region; and
c) means for pivotally securing said elongated handle second end within said receiving slot, thereby functionally engaging said first and second gripping force generating means.

2. An open-end self-adjusting wrench for use in grasping variably sized objects according to claim 1, wherein said first gripping force generating means comprises a toothed rail slidably mated within said receiving channel.

3. An open-end self-adjusting wrench for use in grasping variably sized objects according to claim 1, wherein said second gripping force generating means comprises a toothed radial perimeter at said second end.

4. An open-end self-adjusting wrench for use in grasping variably sized objects, comprising:
a) a jaw assembly comprising:
i) a first jaw member having a first object gripping surface extending into a aperture containing base region, wherein said aperture within said base region comprises a receiving channel proximate to said first object gripping surface and a receiving slot distal to said first object gripping surface;
ii) a second jaw member having a second object gripping surface and a toothed rail slidably mated within said receiving channel;
b) an elongated handle having first and second ends comprising:
i) a grasping region at said first end and
ii) a toothed radial perimeter at said second end, whereby said toothed rail and said toothed radial perimeter mesh with one another to produce an object grasping force on the object between said first and second object grasping surfaces when appropriate force is exerted on said elongated handle grasping region; and
c) means for pivotally securing said elongated handle second end within said receiving slot, thereby functionally engaging said toothed rail with said toothed radial perimeter.

5. An open-end self-adjusting wrench for use in grasping variably sized objects, comprising:
a) a jaw assembly comprising:
i) a first jaw member having a first object gripping surface extending into a cavity containing base having a first anchor pin receiving aperture, wherein said cavity within said base comprises a receiving channel proximate to said first object gripping surface and a receiving slot distal to said first object gripping surface;
ii) a second jaw member having a second object gripping surface and a toothed rail slidably mated within said receiving channel;
b) an elongated handle having first and second ends comprising:
i) a grasping region at said first end and
ii) a toothed radial perimeter at said second end having a second anchor pin receiving aperture, whereby said toothed rail and said toothed radial perimeter mesh with one another to produce an object grasping force on the object between said first and second object grasping surfaces when appropriate force is exerted on said elongated handle grasping region; and
c) an anchor pin for pivotally securing said elongated handle second end within said receiving slot by means of said first and second anchor pin receiving apertures, thereby functionally engaging said toothed rail with said toothed radial perimeter.

6. An open-end self-adjusting wrench for use in grasping variably sized objects according to claim 5, further comprising pivot-facilitating notches bracketing said toothed radial perimeter at said handle second end.

7. An open-end self-adjusting wrench for use in grasping variably sized objects, comprising:
a) a jaw assembly comprising:
i) a first jaw member having a first object gripping surface extending into a cavity containing base having a first anchor pin receiving aperture, wherein said cavity within said base comprises a key-rail channel proximate to said first object gripping surface and a handle-receiving slot distal to said first object gripping surface;
ii) a second jaw member having a second object gripping surface and a toothed key-rail mated within said key-rail channel, thereby aligning said first and said second object gripping surfaces to directly oppose one another, whereby said toothed key-rail slides within said key-rail channel to grasp and release said object between said first and said second object gripping surfaces;
b) an elongated handle having first and second ends comprising:
i) a grasping region at said first end and
ii) a toothed radial perimeter at said second end having a second anchor pin receiving aperture, whereby said toothed key-rail and said toothed radial perimeter mesh with one another to produce an object grasping force on the object between said first and second object grasping surfaces when an appropriate force is exerted on said elongated handle grasping region; and
c) an anchor pin for pivotally securing said elongated handle second end within said receiving slot by means of said first and second anchor pin receiving apertures, thereby securing the meshing of said toothed key-rail with said toothed radial perimeter.

8. An open-end self-adjusting wrench for use in grasping variably sized objects according to claim 7, further comprising pivot-facilitating notches bracketing said toothed radial perimeter at said handle second end.
